(19) United States
(12) Patent Application Publication
(10) Pub. No.: US 2025/0368149 A1
(43) Pub. Date: Dec. 4, 2025

(54) AUTOMOBILE EXTERIOR PROTECTION DEVICE

(71) Applicants: David Havlovic, Hobe Sound, FL (US); Elizabeth Lynn Webb, Hobe Sound, FL (US)

(72) Inventors: David Havlovic, Hobe Sound, FL (US); Elizabeth Lynn Webb, Hobe Sound, FL (US)

(21) Appl. No.: 19/222,632

(22) Filed: May 29, 2025

Related U.S. Application Data
(60) Provisional application No. 63/652,953, filed on May 29, 2024.

(51) Int. Cl. B60R 13/04; B60R 19/38; B60R 19/42

(52) U.S. Cl. CPC B60R 13/043; B60R 19/38; B60R 19/42

(57) ABSTRACT

A device for attachment to the sides of a vehicle to protect against dents when parked next to other vehicles includes an elongated tubular foam member having a hollow axial passage extending therethrough between opposite open ends. A rubber cord, string or cable extends through the axial passage and attaches to suction cups beyond the opposite open ends of the tubular foam member. The suction cups releasably secure the device to the vehicle exterior so that the tubular foam member is held and positioned generally horizontally along the side door(s) of the vehicle.

This non-provisional patent application is based on provisional patent application Ser. No. 63/652,953 filed on May 29, 2024.

### BACKGROUND OF THE INVENTION

### Field of the Invention

This invention relates to a device for protecting the exterior body of an automobile from minor dents, scratches and other surface damage resulting from impingement of objects, such as carelessly opened doors of adjacent automobiles.

### Description of the Related Art

Virtually every automobile owner has experienced the annoyance of getting a dent (commonly referred to as a “ding”) on the sides of their vehicle when parked in locations where other vehicles are parked in close proximity and an occupant traveling in the adjacently parked vehicle carelessly opens a door and causes the door to bang into the side of the owner's automobile. When the door edge of the adjacent automobile impacts the other automobile, it creates a dent in the side of the automobile, usually on the door or side panels.

While there are services that remove minor dents in the exterior of an automobile, it can be a considerable expense to the vehicle owner. Moreover, even when the dent is professionally removed, the vehicle exterior is never quite the same, and when viewed from certain angles, the surface imperfection can be seen.

While various devices have been proposed in the prior art to prevent damage to the vehicle exterior, particularly from opening of doors of adjacently parked vehicles, many are cumbersome, difficult to install, or are intended to be permanently installed. Moreover, many of these prior art devices are unsightly and may cause some damage to the vehicle exterior themselves.

Accordingly, there remains a need for a simple, low-cost device that is easily attached and removed from the sides of a vehicle exterior in order to protect the vehicle from dents when parked next to other vehicles, such as in a parking lot. Moreover, there is a need for a device that easily attaches to the sides of a vehicle to protect against dents (i.e., dings) and wherein the device is inexpensive, highly effective, and will not cause any marks or damage to the vehicle. Still further, there is a need for a device for protecting the exterior of an automobile from dents (dings), and wherein the device has a low profile when installed, thereby not altering the appearance of the automobile.

### SUMMARY OF THE INVENTION

The present invention is directed to a device for attachment to the sides of a vehicle to protect against dents (commonly referred to as “dings”) when parked next to other vehicles, and particularly in parking spots in a parking lot. The device includes an elongated tubular foam member having a hollow axial passage extending through the entire length of the tubular foam member. The opposite ends of the tubular foam member are open and define opposite ends of the hollow axial passage. A rubber cord, string or cable extends through the axial passage and out from the opposite open ends. Suction cups are attached to the opposite ends of the rubber cord, string or cable beyond the opposite open ends of the tubular member. The suction cups releasably secure the device to the vehicle exterior so that the tubular foam member is held and positioned generally horizontal along the sides of the vehicle, particularly the doors and, possibly side panels. Ideally, the device is attached to the sides of the vehicle so that it extends along the outermost curvature or bulges of the side doors and/or panels of the vehicle which are most prone to be hit by an opening door of a vehicle parked next to the vehicle that is protected by the device. Thus, when a door of an adjacent vehicle is opened, the edge of the door will strike the elongated tubular foam member which acts as a bumper, while preventing contact between the edge of the door of the adjacent vehicle and the protected vehicle's body (i.e., the side doors and/or side panels). The suction cups have tabs that are pulled to easily release the suction cups from the side of the vehicle, without leaving any marks or damage to the vehicle exterior finish.

### BRIEF DESCRIPTION OF THE DRAWINGS

For a fuller understanding of the nature of the present invention, reference should be had to the following detailed description taken in connection with the accompanying drawings in which:

FIG. 1 is a perspective view showing the device of the present invention attached to the side of a vehicle, and extending along the side of the vehicle, particularly the door and a portion of a side panel just to the rear of the door;

FIG. 2 is an isolated perspective view showing a suction cup secured to the device, and particularly a rubber cord that extends out from an open end of the elongated tubular foam member of the device and which is tied to the suction cup;

FIG. 3 is a rear perspective view showing the device of the present invention secured to the side of a vehicle, and the door of an adjacent parked vehicle opened and striking the elongated tubular foam member of the device, thereby preventing contact of the door edge with the side of the protected vehicle; and

FIG. 4 is a front perspective view showing the open door of the adjacent parked vehicle striking the elongated tubular foam member of the device of the present invention, thereby protecting the side door of the protected vehicle.

Like reference numerals refer to like parts throughout the several views of the drawings.

### DETAILED DESCRIPTION OF THE PREFERRED EMBODIMENT

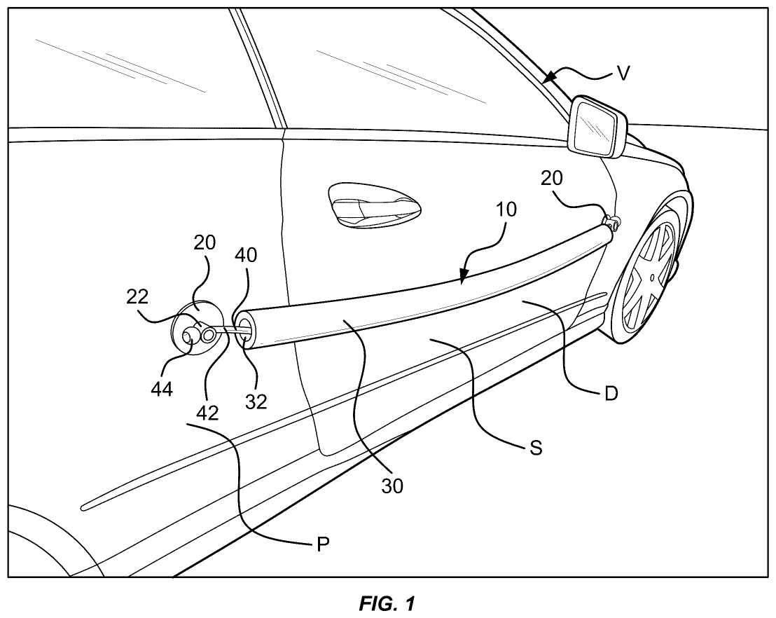

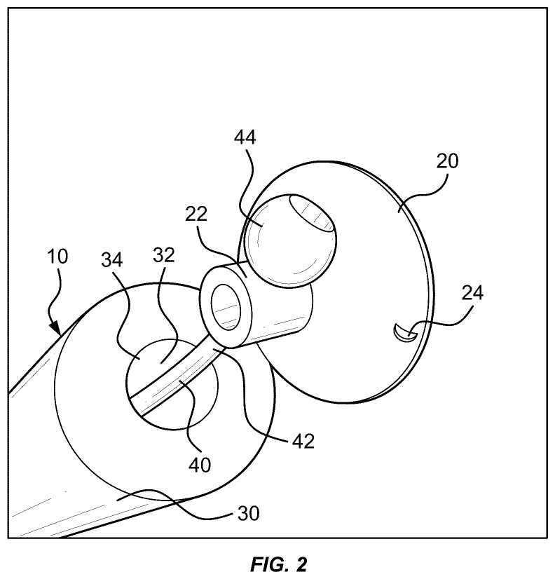

Referring to the several views of the drawings, and initially FIGS. 1 and 2, the automobile exterior protection device of the present invention is shown and is generally indicated as 10. As seen in FIG. 1, the protection device 10 attaches to the exterior side S of a vehicle V with the use of two suction cups 20. In the operative position, as seen in FIG. 1, an elongate tubular foam member 30 of the device 10 extends generally horizontally along the exterior side S of the vehicle V, and particularly the side door(s) D of the vehicle V, as well as possibly a side panel P of the vehicle V, or at least a portion of a side panel of the vehicle. The elongated tubular foam member 30 preferably extends along the outermost bulging portion of the side S of the vehicle V, to thereby prevent a door from an adjacent vehicle striking any portion of the side S of the protected vehicle V. In one embodiment, the elongated tubular foam member 30 is formed of an extruded polyethylene foam.

As seen in FIG. 2, the suction cups 20 are secured to an end portion 42 of a rubber cord 40 that extends entirely through a hollow axial passage 32 of the elongated tubular foam member 30. A segment of approximately 6 to 12 inches of the rubber cord extends beyond an open end 34 of the hollow axial passage 32 at each of the opposite ends of the elongated tubular foam member 30 to allow sufficient length for securing the end portion 42 of the rubber cord 40 to the suction cups 20. As seen in FIG. 2, the end portion 42 of the rubber cord 40 extends through openings in a stub portion 22 of the suction cup 20. A stopper member 44, such as a rigid ball or knob, is fixedly secured to a distal end of the rubber cord 40 to prevent the end of the cord 40 from pulling back through the stub portion 22 and separating from the suction cups at each end portion 42 of the cord 40. As seen in FIG. 1, a suction cup 20 is attached to each end of the device, on the opposite end portions 42 of the rubber cord 40 in the manner as described above. It should be noted that, while the use of a rubber cord is preferred in at least one embodiment, the material of the cord may be that of a braided rope or cable, or other cord, rope or string-type member. In one embodiment, the suction cups are 3.25 inches in diameter and formed of a soft vinyl material. In one embodiment, the rubber cord 40 is 3/16 of an inch in diameter and has a solid core.

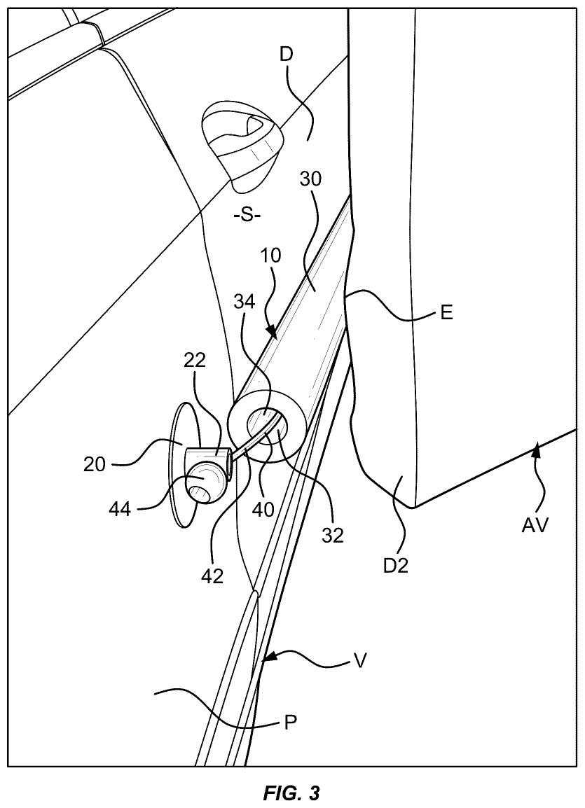

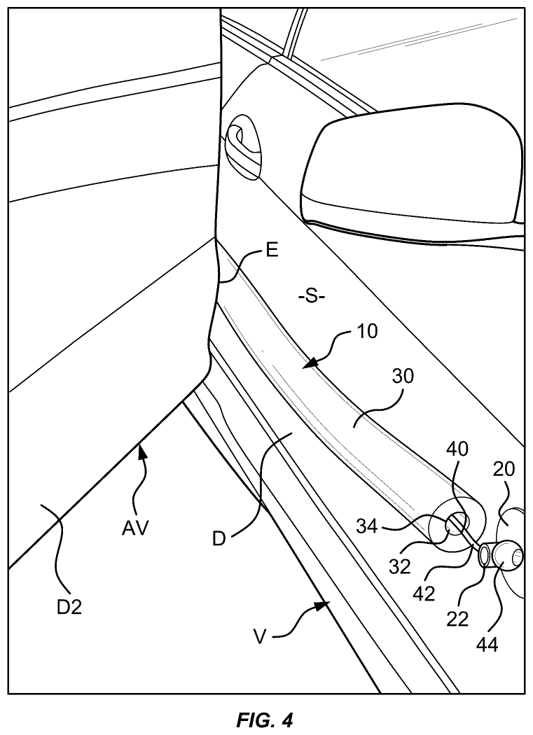

As seen in FIGS. 3 and 4, with the automobile exterior protection device 10 of the present invention properly secured to the side S of the vehicle V, when the door D2 of an adjacent vehicle AV is opened, the edge E of the opened door D2 will strike the elongated tubular foam member 30 which acts as a bumper, preventing the edge E of the door D2 from striking the side S of the protected vehicle V, and thereby avoiding a dent (i.e., ding) in the side door D or side panel P of the protected vehicle V.

When the vehicle owner arrives at their vehicle to leave the parking space, the vehicle owner can easily remove the protection device 10 by grabbing tabs 24 on each of the suction cups 20 and pulling with slight pressure, thereby easily releasing the suction cups 20 from attachment to the side S of the vehicle V, without leaving any marks or other damage to the finish of the vehicle exterior.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A device for protecting the exterior sides of a parked vehicle, the device comprising:
an elongated tubular foam member having an exterior surface and opposite ends, and a hollow axial passage extending through an entire length of the elongated tubular foam member, and the opposite ends each having an opening in communication with the hollow axial passage, and the openings at the opposite ends of the elongated tubular foam member defining opposite ends of the hollow axial passage;
a flexible cord extending through the hollow axial passage and out from the opposite ends of the hollow axial passage, and the flexible cord including end segments at 9 opposite ends of the flexible cord, and the end segments extending exteriorly of the hollow axial passage at the opposite ends of the tubular foam member;
a first suction cup attached to one of the end segments of the flexible cord and a second suction cup attached to the other end segment at the opposite end of the flexible cord, and the first and second suction cups positionable in spaced relation from the opposite ends of the tubular foam member; and
the first and second suction cups being structured and disposed for releasable attachment to the exterior side of the vehicle to hold the tubular foam member in a generally horizontal position along the exterior side of the vehicle.

2. The device as recited in claim 1 further comprising:
a stub portion extending from a back side of each of the first and second suction cups, and the stub member on each of the first and second suction cups including a transverse axial channel for passage of one of the end segments of the flexible cord therethrough; and
a stop member on a distal end of each of the end segments of the flexible cord for preventing the flexible cord from backing out through the transverse axial channel in the stub portion, and thereby preventing separation of the flexible cord from the first and second suction cups.

3. The device as recited in claim 2 wherein the flexible cord is formed of a rubber material.

4. The device as recited in claim 3 wherein the flexible cord has a solid core.

5. The device as recited in claim 1 wherein the elongated tubular foam member is formed of an extruded polyethene foam.
